(19) United States
(12) Patent Application Publication
(10) Pub. No.: US 2024/0223445 A1
(43) Pub. Date: Jul. 4, 2024

(54) METHOD AND SYSTEM FOR CONFIGURING NETCONF SERVER BY NETCONF CONTROLLER

(71) Applicant: RAKUTEN MOBILE, INC., Tokyo (JP)

(72) Inventors: Alok Singh PAWAR, Indore (IN); Rahul GUPTA, Indore (IN); Aaditya DHARAMPURIKAR, Indore (IN); Aman VIJAYVARGIYA, Indore (IN)

(73) Assignee: RAKUTEN MOBILE, INC., Tokyo (JP)

(21) Appl. No.: 17/923,326

(22) PCT Filed: Sep. 13, 2022
(86) PCT No.: PCT/US2022/043269

§ 371 Date: Nov. 4, 2022

(30) Foreign Application Priority Data
Jul. 8, 2022 (IN) 202241039352

(51) Int. Cl. H04L 41/0806; H04L 9/40; H04L 41/0213

(52) U.S. Cl. CPC H04L 41/0806; H04L 41/0213; H04L 63/166

(57) ABSTRACT

Accordingly, embodiments herein disclose a method for configuring at least one Network Configuration Protocol (NETCONF) server by a NETCONF controller (102). The method includes establishing direct communication between a Network Element(s) (NEs) (500) (e.g., NETCONF server) and an Operational Support System (OSS) device (1000) using a NETCONF protocol to configure the NEs (500) without communicating with an Element Management System (EMS) server. As a result, a process associated with the NEs (500), such as configure/reconfigure/retrieve information, becomes faster and does not require a response from a third entity (e.g., the EMS server, vendor dependent entity, etc.).

### FIELD OF INVENTION

The present disclosure relates to wireless communication, and more specifically related to a method and a system for configuring a Network Configuration Protocol (NETCONF) server by a NETCONF controller.

### BACKGROUND

A Telecommunications Management Network (TMN) model is a set of standards developed by an International Telecommunications Union (ITU-T) for TMN specification. The TMN model's strategic goal is to develop or identify standard interfaces that allows a network to be managed consistently across all network element suppliers. TMN concept has fostered and tracked a number of interconnected efforts to develop standard methods for defining and addressing Network Element(s) (NEs). The TMN model uses Open Systems Interconnection (OSI) management standards as its framework. The TMN model can apply to wireless communications and cable TV networks as well as to private and public wired networks. Furthermore, the TMN model is referred as a TMN pyramid (10a), where the TMN pyramid (10a) includes four logical layers and two additional layers for network management. A Business Management Layer (BML)/Business Support Systems (BSS), a Service Management Layer (SML)/Operational Support System (OSS), a Network Management Layer (NML)/Network Management System (NMS), and an Element Management Layer (EML)/Element Management System (EMS) are among the four logical layers. A Network Element Layer (NEL) and a Physical (PHY) layer are the two additional layers, where the PHY layer is not shown in FIG. 1A.

In some existing systems, the OSS is always connected to the NMS, the EMS, and even devices (e.g., NEs) to gather network health data, identify faults, and resolve them. Furthermore, the OSS must communicate with the EMS to configure/reconfigure the NEs and/or retrieve information about the NEs, which is a limitation of some existing systems. The OSS always sends a request to the EMS for each configuration/re-configuration, and then upon receiving the request, the EMS configures/re-configures the NEs and/or retrieve the information about the NEs. As a result of indirect communication between the NEs and the OSS, a process of configuration/reconfiguration/retrieve information becomes time-consuming, extra overhead/resource wastage in communication, and reliance on the EMS.

Thus, it is desired to address the above-mentioned disadvantages or other shortcomings or at least provide a useful alternative for configuring/reconfiguring the NEs (e.g., NETCONF server) and/or retrieving information about the NEs.

### Object of Invention

The principal object of the embodiments herein is to establish direct communication between a Network Element(s) (NEs) (e.g., NETCONF server) and an Operational Support System (OSS) device using a NETCONF protocol to configure the NEs without communicating with an Element Management System (EMS) server. Therefore, in the proposed system the EMS server is eliminated and thereby facilitating the direct communication between the NEs and the OSS device. As a result, a process associated with the NEs, such as configure/reconfigure/retrieve information about the NEs, becomes faster and does not require a response from a third entity (e.g., the EMS server, vendor dependent entity, etc.) for completing the process.

Another object of the embodiment herein is to establish a Transport Layer Security (TLS) session with the NEs based on successful validation of a present host key of the NEs and/or a present certificate of the NEs.

Another object of the embodiment herein is to establish a NETCONF session with the NEs using the established TLS session, where the NETCONF controller maintains the NETCONF session using a NETCONF supervision process and a watchdog process.

### SUMMARY

Accordingly, embodiments herein disclose a method for configuring a Network Configuration Protocol (NETCONF) server(s) by a NETCONF controller. The method includes establishing, by the NETCONF controller, direct communication between the NETCONF server(s) and an Operational Support System (OSS) device using a NETCONF protocol. Further, the method includes configuring, by the NETCONF controller, the NETCONF server(s) without communicating with an Element Management System (EMS) server upon successful establishment of the direct communication.

In an embodiment, where establishing, by the NETCONF controller, the direct communication between the NETCONF server(s) and the OSS device using the NETCONF protocol includes receiving, by the NETCONF controller, a Transmission Control Protocol (TCP) connection request from the NETCONF server(s): establishing, by the NETCONF controller, a TCP connection with the NETCONF server(s) based on receiving the TCP connection request: establishing, by the NETCONF controller, a Transport Layer Security (TLS) session with the NETCONF server(s) using the established TCP connection; and establishing, by the NETCONF controller, a NETCONF session with the NETCONF server(s) using the established TLS session.

In an embodiment, the method further includes maintaining, by the NETCONF controller, the established NETCONF session using a NETCONF supervision process and a watchdog process.

In an embodiment, where establishing, by the NETCONF controller, the TLS session with the NETCONF server(s) using the established TCP connection includes determining, by the NETCONF controller, a present host key of the NETCONF server(s) and/or a present certificate of the NETCONF server(s); validating, by the NETCONF controller, the present host key and/or the present certificate based on a certificate path and/or a comparison: determining, by the NETCONF controller, whether the present host key and/or the present certificate is successfully validated: and establishing, by the NETCONF controller, the TLS session with the NETCONF server(s) on successful validation of the present host key and/or the present certificate.

In an embodiment, where validating, by the NETCONF controller, the present certificate based on the certificate path includes utilizing, by the NETCONF controller, the certificate path to confirm whether the present certificate is a valid chain of trust to a preconfigured issuer certificate to establish the TLS session; and encoding, by the NETCONF controller, the present certificate with an identifier that the NETCONF server(s) was aware of prior to the connection attempt to establish the TLS session.

In an embodiment, where validating, by the NETCONF controller, the present host key and/or the present certificate based on the comparison includes comparing, by the NETCONF controller, the present host key with a previously trusted host key to establish the TLS session; and comparing, by the NETCONF controller, the present certificate with a previously trusted certificate to establish the TLS session.

In an embodiment, where the NETCONF supervision process includes identifying, by the NETCONF controller, a virtual identity of the NETCONF server(s) and a physical identity of the NETCONF server(s); identifying, by the NETCONF controller, a serial number of the NETCONF server(s) and/or a hostname of the NETCONF server(s); determining, by the NETCONF controller, a channel object based on the serial number and/or the hostname: creating, by the NETCONF controller, a map to store the channel object: and storing, by the NETCONF controller, the NETCONF server(s) with a unique key and priority, where the NETCONF server(s) executes a task based on the priority.

In an embodiment, where maintaining, by the NETCONF controller, the established NETCONF session using the NETCONF supervision process and the watchdog process includes receiving, by the NETCONF controller, a supervision notification message from the NETCONF server(s): performing, by the NETCONF controller, the NETCONF supervision process upon receiving the supervision notification message to maintain the established NETCONF session: sending, by the NETCONF controller, a watchdog request to the NETCONF server(s), where the watchdog request includes a time interval information associated with the supervision notification message: and performing, by the NETCONF controller, the watchdog process upon receiving the watchdog request to maintain the established NETCONF session.

In an embodiment, where configuring, by the NETCONF controller, the NETCONF server(s) without communicating with the EMS server upon successful establishment of the direct communication includes generating, by the NETCONF controller, configuration of a first day and a second day for the NETCONF server(s); pushing, by the NETCONF controller, the generated configuration to the NETCONF server without communicating with the EMS server; sending, by the NETCONF controller, a Remote procedure call (RPC) request to the NETCONF server(s), where the RPC request includes, one or more, configuration modification information, configuration commitment information, configuration query, and configuration status: receiving, by the NETCONF controller, a RPC response from the NETCONF server(s); and storing, by the NETCONF controller, the configuration modification information, the configuration commitment information, the configuration query, and the configuration status into the NETCONF server(s).

In an embodiment, the method includes communicating, by the NETCONF controller, with a Configuration Management As A Service (CMAAS) of the OSS device through an Application Programming Interface (API) gateway to access, one or more, a parameter library, NETCONF Micro service (MS) information, NETCONF gNodeB (gNB) information, and NETCONF task request.

In an embodiment, the method includes communicating, by the NETCONF controller, with the CMAAS of the OSS device through a Netconf controller gateway.

Accordingly, embodiments herein disclose the NETCONF controller for configuring the NETCONF server(s). The NETCONF controller includes a processor and a memory. The processor establishes the direct communication between the NETCONF server(s) and the OSS device using the NETCONF protocol. Further, the processor configures the NETCONF server(s) without communicating with the EMS server upon successful establishment of the direct communication.

Accordingly, embodiments herein disclose a Computer Program Product (CPP) for configuring the NETCONF server(s) by the NETCONF controller. The CPP includes a computer executable program code recorded on a computer readable non-transitory storage medium, wherein said computer executable program code when executed causing the actions includes establishing the direct communication between the NETCONF server(s) and the OSS device using the NETCONF protocol; and configuring the NETCONF server(s) without communicating with the EMS server upon successful establishment of the direct communication.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein, and the embodiments herein include all such modifications.

### BRIEF DESCRIPTION OF FIGURES

This invention is illustrated in the accompanying drawings, throughout which like reference letters indicate corresponding parts in the various figures. The embodiments herein will be better understood from the following description with reference to the drawings, in which:

FIG. 1A illustrates a Telecommunications Management Network (TMN) model, according to a prior art:

FIG. 1B is a sequence diagram illustrating a method for establishing a NETCONF call home, according to a prior art:

FIG. 2 illustrates a block diagram of a system for configuring a NETCONF server(s) by a NETCONF controller, according to an embodiment as disclosed herein;

FIG. 3 is a flow diagram illustrating a method for configuring the NETCONF server(s) by the NETCONF controller, according to an embodiment as disclosed herein:

FIG. 4A is a flow diagram illustrating a method for establishing a Transport Layer Security (TLS) session with the NETCONF server(s) based on successful validation of a present host key of the NETCONF server(s) and/or a present certificate of the NETCONF server(s), according to an embodiment as disclosed herein:

FIG. 4B is a flow diagram illustrating a method for a NETCONF supervision process, according to another embodiment as disclosed herein;

FIG. 5 is a sequence diagram illustrating a method for maintaining a NETCONF session with the NETCONF server(s) using the NETCONF supervision process and a watchdog process, according to another embodiment as disclosed herein; and

FIG. 6 is a flow diagram illustrating a method for configuring the NETCONF server(s) without communicating with an EMS server upon successful establishment of the NETCONF session, according to another embodiment as disclosed herein.

### DETAILED DESCRIPTION OF INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as units or modules or the like, are physically implemented by analog or digital circuits such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the invention. Likewise, the blocks of the embodiments may be physically combined into more complex blocks without departing from the scope of the invention

The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

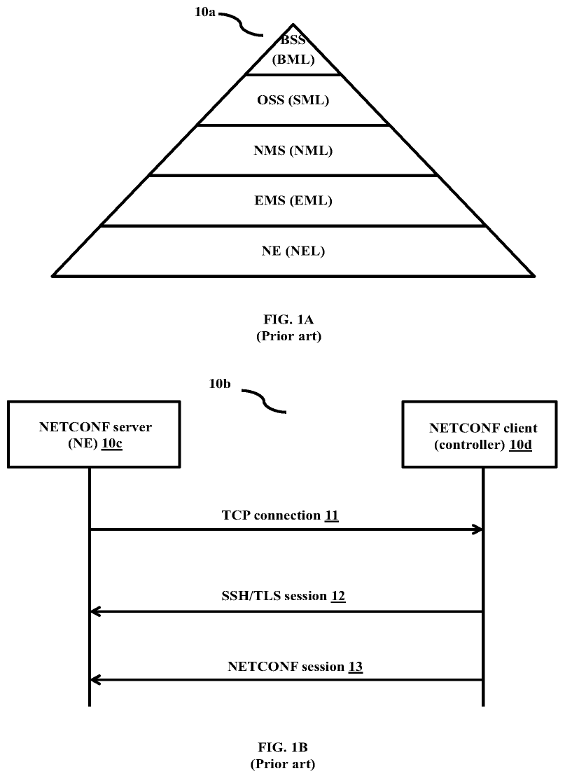

FIG. 1B is a sequence diagram (10b) illustrating a method for establishing a NETCONF call home, according to prior art.

The NETCONF call home, also known as a reverse secure socket shell (SSH), is a technique for connecting Network Functions Virtualization (NFV) and Software-Defined Networking (SDN) devices to service provider control systems and protecting Virtual Customer Premises Equipment (vCPE), which is typically deployed behind a cable modem or a firewall. Furthermore, the NETCONF call home enables a NETCONF server (10c) (e.g. Network Elements (NEs)/network device) to establish a secure connection with a NETCONF client (10d).

The NETCONF call home enables secured connectivity between the NFV/SDN devices and control systems when the NETCONF client (10d) is otherwise unable to initiate an SSH session/connection (12) directly to the NETCONF server on the NFV/SDN device. The NETCONF call home does this by reversing the way a TCP connection (11) is establishing between the NETCONF client (10d) and the NETCONF server (10c). Normally, the SSH client initiates and establishes a SSH/TLS session. However, when reversing this process with the NETCONF call home, the NETCONF client (10d) (SSH server) initiates the SSH/TLS session, rather than the NETCONF server (10c) initiates.

There are several reasons to prefer the NETCONF call home. The NETCONF call home contributes for providing a better network service to the users of the NETCONF call home. The NETCONF call home is generally useful for both initial network element deployment and ongoing network element management. When network elements are deployed behind the firewall that prevents management access to an internal network, the connection for control/management purposes cannot be established. The connection can be established by reversing the direction without losing any firewall access restrictions. Thus, the NETCONF call home introduces a new connectivity mechanism that is also secure. The NETCONF call home enables the NEs to proactively connect and register itself when powered on for a first time. This helps in auto-discovery and zero-touch provisioning of network elements.

In general, when a dynamic Internet Protocol (IP) address is used and lease expires, that can be difficult for the NETCONF controller (10d) to identify and connect to the NETCONF server (10c), making difficult to re-establish a connection. This issue is solved by reversing two connections (12, 13) and connecting the NETCONF client (10d) to the NETCONF server (10c). When connecting private networks to data centers, operators may prefer that centralized management to initiate the connection because that is easier to secure the one open port in the data centers rather than the several ports that may be opened in many private networks and end devices. As networks become more advanced and ingrained in daily life, more and more elements will be virtualized. By removing physical equipment from the network, both a service provider and a customer benefit from increased safety and cost-efficiency. However, manually configuring and managing each of these virtualized elements would be a logistical nightmare. As a result, alternative techniques such as the NETCONF call home are required to securely connect and manage the virtualized elements without the need for manual intervention. The NETCONF call home is an important step forward for modern networking. It benefits both the consumer and the service provider by providing improved security and support.

Furthermore, the NETCONF server (10c) provides a northbound interface that can be used to communicate with any network device that supports the NETCONF protocol. That includes a wide range of remote procedure calls for performing various operations in a field. This enables secure TLS/SSH communication between the devices (e.g., NETCONF server (10c)). The NETCONF call home has a secure connection and data exchange between NETCONF supported network devices and OSS services, achieving a secure connection between devices via the NETCONF protocol over TLS/SSH connectivity. For this purpose, we need a vendor's authentication details, such as login credentials/certificates, to exchange between the NETCONF client (10d) and the NETCONF server (10c) (or both the devices). So, a method for authenticating vendor information is required.

Accordingly, embodiments herein disclose a method for configuring a Network Configuration Protocol (NETCONF) server(s) by a NETCONF controller. The method includes establishing, by the NETCONF controller, direct communication between the NETCONF server(s) and an Operational Support System (OSS) device using a NETCONF protocol. Further, the method includes configuring, by the NETCONF controller, the NETCONF server(s) without communicating with an Element Management System (EMS) server upon successful establishment of the direct communication.

Accordingly, embodiments herein disclose the NETCONF controller for configuring the NETCONF server(s). The NETCONF controller includes a processor and a memory. The processor establishes the direct communication between the NETCONF server(s) and the OSS device using the NETCONF protocol. Further, the processor configures the NETCONF server(s) without communicating with the EMS server upon successful establishment of the direct communication.

Accordingly, embodiments herein disclose a Computer Program Product (CPP) for configuring the NETCONF server(s) by the NETCONF controller. The CPP includes a computer executable program code recorded on a computer readable non-transitory storage medium, wherein said computer executable program code when executed causing the actions includes establishing the direct communication between the NETCONF server(s) and the OSS device using the NETCONF protocol: and configuring the NETCONF server(s) without communicating with the EMS server upon successful establishment of the direct communication.

Unlike existing methods and systems, the proposed method allows the NETCONF controller to establish the direct communication between the NEs (e.g., NETCONF server) and the OSS device using the NETCONF protocol to configure the NEs without communicating with the EMS server. Therefore, in the proposed system the EMS server is eliminated and thereby facilitating the direct communication between the NEs and the OSS device. As a result, a process associated with the NEs, such as configure/reconfigure/retrieve information about the NEs, becomes faster and does not require a response from a third entity (e.g., the EMS server, vendor dependent entity, etc.) for completing the process.

Unlike existing methods and systems, the proposed method allows the NETCONF controller to establish a Transport Layer Security (TLS) session with the NEs based on successful validation of a present host key of the NEs and/or a present certificate of the NEs.

Unlike existing methods and systems, the proposed method allows the NETCONF controller to establish a NETCONF session with the NEs using the established TLS session, where the NETCONF controller maintains the NETCONF session using a NETCONF supervision process and a watchdog process

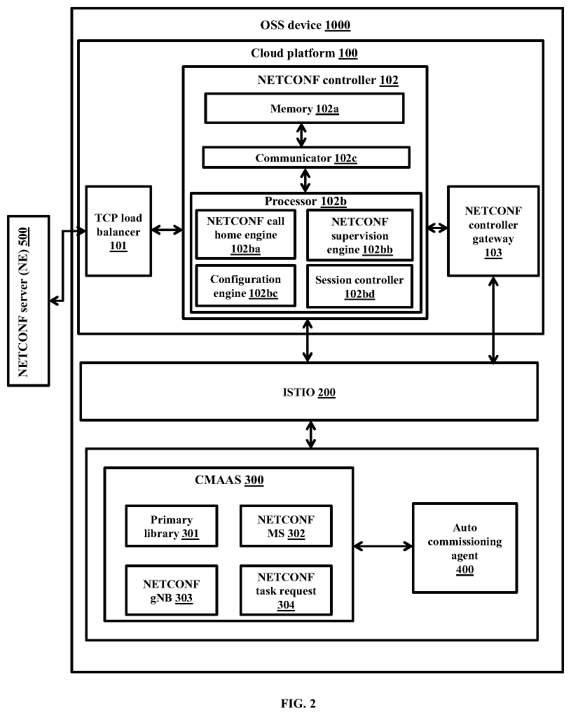

Referring now to the drawings, and more particularly to FIGS. 2 through 6, where similar reference characters denote corresponding features consistently throughout the figures, there are shown preferred embodiments.

FIG. 2 illustrates a block diagram of a system for configuring a NETCONF server(s) (500) by a NETCONF controller (102), according to an embodiment as disclosed herein.

The system includes an Operations support systems (OSS) device (1000) and the NETCONF server(s) (500). The OSS device (1000) device includes a cloud platform (100) (e.g. Robin Kubernetes platform), an ISTIO (200), a Configuration Manager as a Service (CMAAS) (300), and an auto commissioning agent (400). The cloud platform (100) includes a TCP load balancer (101), the NETCONF controller (102), and a NETCONF controller gateway (103). In an embodiment, the NETCONF controller (102) includes a memory (102a), a processor (102b), and a communicator (102c).

In an embodiment, the memory (102a) stores configuration of the NETCONF server(s) (500), a present host key of the NETCONF server(s) (500) and a present certificate of the NETCONF server(s) (500), a unique key and priority of the NETCONF server(s) (500). The memory (102a) stores instructions to be executed by the processor (102b). The memory (102a) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (102a) may, in some examples, be considered a non-transitory storage medium. The term “non-transitory” may indicate that the storage medium is not embodied in a carrier wave or a propagated signal. However, the term “non-transitory” should not be interpreted that the memory (102a) is non-movable. In some examples, the memory (102a) can be configured to store larger amounts of information than the memory. In certain examples, a non-transitory storage medium may store data that can, over time, change (e.g., in Random Access Memory (RAM) or cache). The memory (102a) can be an internal storage unit or it can be an external storage unit of the NETCONF controller (102) a cloud storage, or any other type of external storage.

The processor (102b) communicates with the memory (102a), and the communicator (102c). The processor (102b) is configured to execute instructions stored in the memory (102a) and to perform various processes. The processor (102b) may include one or a plurality of processors, maybe a general-purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU).

The communicator (102c) is configured for communicating internally between internal hardware components and with external devices (e.g. ISTIO (200), NETCONF controller gateway (103), etc.) via one or more networks (e.g. Radio technology). The communicator (102c) includes an electronic circuit specific to a standard that enables wired or wireless communication.

The processor (102b) is implemented by processing circuitry such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like.

In an embodiment, the processor (102b) includes a NETCONF call home engine (102ba), a NETCONF supervision engine (102bb), a configuration engine (102bc), and a session controller (102bd).

The NETCONF call home engine (102ba) receives a Transmission Control Protocol (TCP) connection request from the NETCONF server (500). The NETCONF call home engine (102ba) establishes a TCP connection with the NETCONF server (500) based on the TCP connection request. The NETCONF call home engine (102ba) establishes a Transport Layer Security (TLS) session with the NETCONF server (500) using the established TCP connection. The NETCONF call home engine (102ba) establishes a NETCONF session with the NETCONF server (500) using the established TLS session.

Furthermore, the NETCONF call home engine (102ba) determines the present host key of the NETCONF server(s) (500) and/or the present certificate of the NETCONF server(s) (500). The NETCONF call home engine (102ba) validates the present host key and/or the present certificate based on a certificate path and/or a comparison. The NETCONF call home engine (102ba) determines whether the present host key and/or the present certificate is successfully validated. The NETCONF call home engine (102ba) establishes the TLS session with the NETCONF server(s) (500) on successful validation of the present host key and/or the present certificate.

Furthermore, the NETCONF call home engine (102ba) utilizes the certificate path to confirm whether the present certificate is a valid chain of trust to a preconfigured issuer certificate to establish the TLS session. For example, list of certificates that extends from the certificate which is currently hold, by the NE (500) (e.g. device)) all the way back to a Root Certificate Authority (CA) is referred to as the certificate chain of trust. Only a small number of Root CAs may be trusted by an organization. If the certificate is trusted, which also trust the service provider who issued it, and so on. Which continues until locates the Root CA, where the certificate is examined and the certificate's trustworthiness established. All intermediate CAs and the server's certificate are automatically regarded as valid if the root CA has a trusted and valid certificate. The NETCONF call home engine (102ba) encodes the present certificate with an identifier that the NETCONF server(s) (500) was aware of prior to the connection attempt to establish the TLS session (e.g., TCP connection over TLS means TCP connection is being initiated by devices and the NETCONF controller (102) listens that TCP and encrypt TCP channel with TLS by initializing SSL context.).

Furthermore, the NETCONF call home engine (102ba) compares the present host key with a previously trusted host key to establish the TLS session. The NETCONF call home engine (102ba) compares the present certificate with a previously trusted certificate to establish the TLS session.

The NETCONF supervision engine (102bb) maintains the established NETCONF session using a NETCONF supervision process and a watchdog process. The NETCONF supervision engine (102bb) identifies a virtual identity of the NETCONF server(s) (500) and/or a physical identity of the NETCONF server(s) (500). The NETCONF supervision engine (102bb) identifies a serial number of the NETCONF server(s) (500) and/or a hostname of the NETCONF server(s) (500). The NETCONF supervision engine (102bb) determines a channel object based on the serial number and/or the hostname. For maintaining a call home session, the NETCONF supervision engine (102bb) creates a map to store the channel object on basis of a host port first till the NETCONF supervision engine (102bb) gets the serial number and/or the hostname. The NETCONF supervision engine (102bb) creates a map to store the channel object. The NETCONF supervision engine (102bb) stores the NETCONF server(s) (500) with a unique key and priority, where the NETCONF server(s) (500) executes a task (e.g., call home and supervision, configuration provisioning, etc.) based on the priority.

For example, in the call home and supervision task, first, a hello message is exchanged between the NETCONF controller (102) and server. Next, the NETCONF controller (102) executes a get modules task to determine whether the device (e.g., NE (500)) is physical or virtual. Based on this result, the NETCONF controller (102) then executes a next task to obtain the device serial number or hostname. Finally, the NETCONF controller (102) executes a supervision RPC request to subscribe to a stream from the device to get notification continuously based on a watchdog RCP request timer to maintain session between the device and the NETCONF controller (102). Furthermore, there are three subtasks in the configuration provisioning task. A first task is to generate configuration, then a second task is to push the configuration to the device, and a third task is to execute commit and confirmed commit requests to the device to save the configuration to the device's end.

Furthermore, the NETCONF supervision engine (102bb) receives a supervision notification message from the NETCONF server(s) (500). The NETCONF supervision engine (102bb) performs the NETCONF supervision process upon receiving the supervision notification message to maintain the established NETCONF session. The NETCONF supervision engine (102bb) sends a watchdog request to the NETCONF server(s) (500), where the watchdog request includes a time interval information associated with the supervision notification message. The NETCONF supervision engine (102bb) performs the watchdog process upon receiving the watchdog request to maintain the established NETCONF session.

The configuration engine (102bc) generates the configuration of a first day and a second day for the NETCONF server(s) (500). The configuration engine (102bc) pushes the generated configuration to the NETCONF server (500) without communicating with the EMS server. The configuration engine (102bc) sends a Remote Procedure Call (RPC) request to the NETCONF server(s) (500), where the RPC request includes a configuration modification information, configuration commitment information, configuration query, and configuration status. The configuration engine (102bc) receives a RPC response from the NETCONF server (500). The configuration engine (102bc) stores the configuration modification information, the configuration commitment information, the configuration query, and the configuration status into the NETCONF server(s) (500).

The session controller (102bd) communicates with the CMAAS (300) of the OSS device (1000) through an Application Programming Interface (API) gateway to access, one of, a parameter library, NETCONF Micro service (MS) information, NETCONF gNodeB (gNB) information, and a NETCONF task request. The session controller (102bd) communicates with the CMAAS (300) of the OSS device (1000) through the NETCONF controller gateway (103).

In an embodiment, the ISTIO (200) is an open source service mesh that overlays existing distributed applications transparently. The powerful features of the ISTIO (200) provides a more consistent and efficient way to secure, connect, and monitor services. The ISTIO (200) enables load balancing, service-to-service authentication, and monitoring with minimal or no service code changes. The ISTIO (200) is a powerful control plane provides essential features such as TLS encryption, strong identity-based authentication and authorization, and secure service-to-service communication in a cluster and automatic load balancing.

In an embodiment, to enrol the certificate (e.g., the present certificate, the previously trusted certificate, etc.) for the TLS session/communication and an auto-commissioning agent instantiate devices (Network Function), a service provider provides a certificate to the NE (500) (e.g., device) and the NETCONF controller (102). Once the network function is instantiated, a call home request is sent to the NETCONF controller (102) via the ISTIO (200)/TCP load balancer (101) (cross cluster communication), and the call home is established after hello messages are exchanged between the NE (500) (e.g., end device) and a client server certificate validation. Another service that is set up in parallel with the NETCONF in order to interface with NETCONF services is the NETCONF controller gateway (103). For instance, the CMAAS (300) (configuration manager as a service) interacts with the NETCONF controller gateway (103) before sending a RPC request to the NETCONF service that will be used.

Although the FIG. 2 shows various hardware components of the system but it is to be understood that other embodiments are not limited thereon. In other embodiments, the system may include less or more number of components. Further, the labels or names of the components are used only for illustrative purpose and does not limit the scope of the invention. One or more components can be combined together to perform same or substantially similar function to configure the NETCONF server(s) (500).

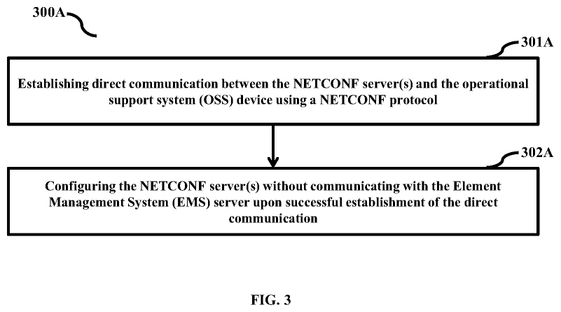

FIG. 3 is a flow diagram (300A) illustrating a method for configuring the NETCONF server(s) (500) by the NETCONF controller (102), according to an embodiment as disclosed herein. Steps (301-302) performs by the NETCONF controller (102).

At step 301A, the method includes establishing the direct communication between the NETCONF server(s) (500) and the OSS device (1000) using the NETCONF protocol. At step 302A, the method includes configuring the NETCONF server(s) (500) without communicating with the EMS server upon successful establishment of the direct communication.

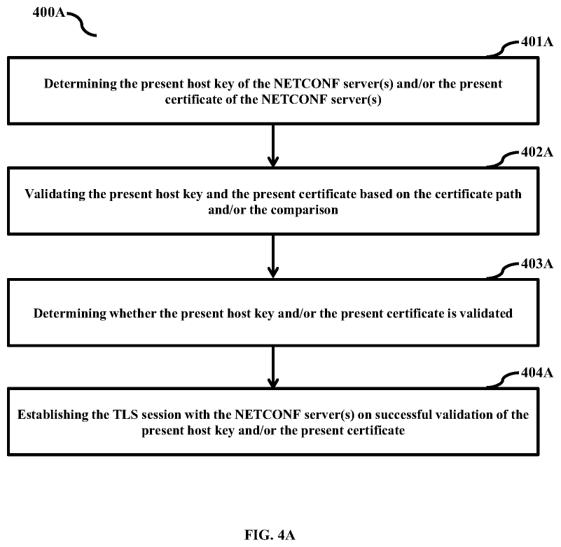

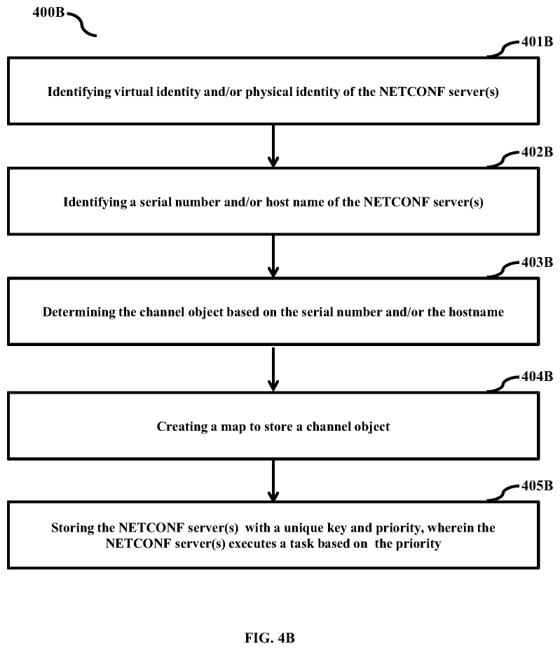

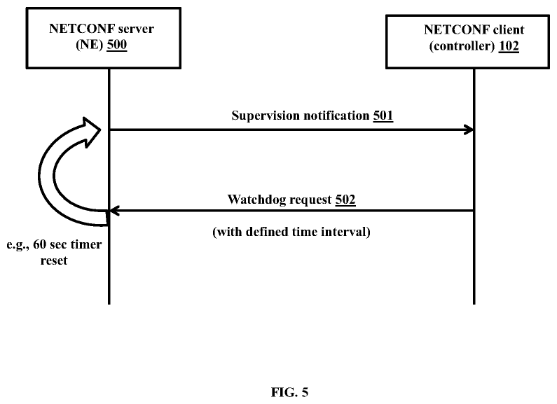

FIG. 4A is a flow diagram (400A) illustrating a method for establishing the TLS session with the NETCONF server(s) (500) based on successful validation of the present host key of the NETCONF server(s) (500) and/or the present certificate of the NETCONF server(s) (500), according to an embodiment as disclosed herein. Steps (401A-404A) performs by the NETCONF controller (102).

At step 401A, the method includes determining the present host key of the NETCONF server(s) (500) and/or the present certificate of the NETCONF server(s) (500). At step 402A, the method includes validating the present host key and/or the present certificate based on the certificate path and/or the comparison. At step 403A, the method includes determining whether the present host key and/or the present certificate are validated. At step 404A, the method includes establishing the TLS session with the NETCONF server(s) (500) on successful validation of the present host key and/or the present certificate.

FIG. 4B is a flow diagram (400B) illustrating a method for the NETCONF supervision process, according to another embodiment as disclosed herein. Steps (401B-405B) performs by the NETCONF controller (102).

At step 401B, the method includes identifying the virtual identity of the NETCONF server(s) (500) and/or the physical identity of the NETCONF server(s) (500). At step 402B, the method includes identifying the serial number of the NETCONF server(s) (500) and/or the hostname of the NETCONF server(s) (500). At step 403B, the method includes determining the channel object based on the serial number and/or the hostname. At step 404B, the method includes creating the map to store the channel object. At step 405B, the method includes storing the NETCONF server(s) (500) with the unique key and priority, where the NETCONF server(s) (500) executes the task based on the priority.

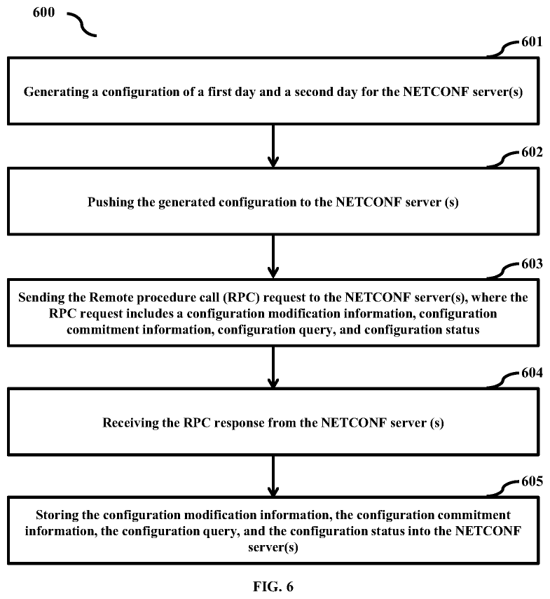

FIG. 5 is a sequence diagram illustrating a method for maintaining the NETCONF session with the NETCONF server(s) (500) using the NETCONF supervision process and the watchdog process, according to another embodiment as disclosed herein.

At step 501, the NETCONF controller (102) receives the supervision notification message from the NETCONF server(s) (500). The NETCONF controller (102) performs the NETCONF supervision process upon receiving the supervision notification message to maintain the established NETCONF session. At step 502, the NETCONF controller (102) sends the watchdog request to the NETCONF server(s) (500), where the watchdog request includes the time interval information associated with the supervision notification message. The NETCONF controller (102) performs the watchdog process upon receiving the watchdog request to maintain the established NETCONF session.

FIG. 6 is a flow diagram (600) illustrating a method for configuring the NETCONF server(s) (500) without communicating with an EMS server upon successful establishment of the NETCONF session, according to another embodiment as disclosed herein. Steps (601-605) performs by the NETCONF controller (102).

At step 601, the method includes generating the configuration of the first day and the second day for the NETCONF server(s) (500). At step 602, the method includes pushing the generated configuration to the NETCONF server(s) (500) without communicating with the EMS server. At step 603, the method includes sending the RPC request to the NETCONF server(s) (500), where the RPC request includes the configuration modification information, configuration commitment information, configuration query, and configuration status. At step 604, the method includes receiving the RPC response from the NETCONF server(s) (500). At step 605, the method includes storing the configuration modification information, the configuration commitment information, the configuration query, and the configuration status in the NETCONF server(s) (500).

The various actions, acts, blocks, steps, or the like in the flow diagram(s) (300A, 400A, 400B, and 600) may be performed in the order presented, in a different order, or simultaneously. Further, in some embodiments, some of the actions, acts, blocks, steps, or the like may be omitted, added, modified, skipped, or the like without departing from the scope of the invention.

The embodiments disclosed herein can be implemented using at least one hardware device and performing network management functions to control the elements.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

We claim:

1. A method for configuring at least one Network Configuration Protocol (NETCONF) server (500) by a NETCONF controller (102), the method comprising:
establishing, by the NETCONF controller (102), direct communication between the at least one NETCONF server (500) and an Operational Support System (OSS) device (1000) using a NETCONF protocol; and
configuring, by the NETCONF controller (102), the at least one NETCONF server (500) without communicating with an Element Management System (EMS) server upon successful establishment of the direct communication.

2. The method as claimed in claim 1, wherein establishing, by the NETCONF controller (102), the direct communication between the at least one NETCONF server (500) and the OSS device (1000) using the NETCONF protocol comprises:
receiving, by the NETCONF controller (102), a Transmission Control Protocol (TCP) connection request from the at least one NETCONF server (500);
establishing, by the NETCONF controller (102), a TCP connection with the at least one NETCONF server (500) based on receiving the TCP connection request;
establishing, by the NETCONF controller (102), a Transport Layer Security (TLS) session with the at least one NETCONF server (500) using the established TCP connection; and
establishing, by the NETCONF controller (102), a NETCONF session with the at least one NETCONF server (500) using the established TLS session.

3. The method as claimed in claim 2, wherein the method further comprises:
maintaining, by the NETCONF controller (102), the established NETCONF session using a NETCONF supervision process and a watchdog process.

4. The method as claimed in claim 2, wherein establishing, by the NETCONF controller (102), the TLS session with the at least one NETCONF server (500) using the established TCP connection comprises:
determining, by the NETCONF controller (102), at least one of a present host key of the at least one NETCONF server (500) and a present certificate of the at least one NETCONF server (500);
validating, by the NETCONF controller (102), the at least one of the present host key and the present certificate based on at least one of a certificate path and a comparison;
determining, by the NETCONF controller (102), whether the at least one of the present host key and the present certificate is successfully validated; and
establishing, by the NETCONF controller (102), the TLS session with the at least one NETCONF server (500) on successful validation of the at least one of the present host key and the present certificate.

5. The method as claimed in claim 4, wherein validating, by the NETCONF controller (102), the present certificate based on the certificate path comprises:
utilizing, by the NETCONF controller (102), the certificate path to confirm whether the present certificate is a valid chain of trust to a pre-configured issuer certificate to establish the TLS session; and
encoding, by the NETCONF controller (102), the present certificate with an identifier that the at least one NETCONF server (500) was aware of prior to the connection attempt to establish the TLS session.

6. The method as claimed in claim 4, wherein validating, by the NETCONF controller (102), the at least one of the present host key and the present certificate based on the comparison comprises:
comparing, by the NETCONF controller (102), the present host key with a previously trusted host key to establish the TLS session; and
comparing, by the NETCONF controller (102), the present certificate with a previously trusted certificate to establish the TLS session.

7. The method as claimed in claim 3, wherein the NETCONF supervision process comprises:
identifying, by the NETCONF controller (102), at least one of a virtual identity of the at least one NETCONF server (500) and a physical identity of the at least one NETCONF server (500);
identifying, by the NETCONF controller (102), at least one of a serial number of the at least one NETCONF server (500) and a hostname of the at least one NETCONF server (500);
determining, by the NETCONF controller (102), a channel object based on the at least one of the serial number and the hostname;
creating, by the NETCONF controller (102), a map to store the channel object; and
storing, by the NETCONF controller (102), the at least one NETCONF server (500) with a unique key and priority, wherein the at least one NETCONF server (500) executes a task based on the priority.

8. The method as claimed in claim 3, wherein maintaining, by the NETCONF controller (102), the established NETCONF session using the NETCONF supervision process and the watchdog process comprises:
receiving, by the NETCONF controller (102), a supervision notification message from the at least one NETCONF server (500);
performing, by the NETCONF controller (102), the NETCONF supervision process upon receiving the supervision notification message to maintain the established NETCONF session;
sending, by the NETCONF controller (102), a watchdog request to the at least one NETCONF server (500), wherein the watchdog request comprises a time interval information associated with the supervision notification message; and
performing, by the NETCONF controller (102), the watchdog process upon receiving the watchdog request to maintain the established NETCONF session.

9. The method as claimed in claim 1, wherein configuring, by the NETCONF controller (102), the at least one NETCONF server (500) without communicating with the EMS server upon successful establishment of the direct communication comprises:
generating, by the NETCONF controller (102), configurations of a first day and a second day for the at least one NETCONF server (500);
pushing, by the NETCONF controller (102), the generated configuration to the at least one NETCONF server (500) without communicating with the EMS server;
sending, by the NETCONF controller (102), at least one Remote Procedure Call (RPC) request to the at least one NETCONF server (500), wherein the at least one RPC request comprises at least one of configuration modification information, configuration commitment information, configuration query, and configuration status;
receiving, by the NETCONF controller (102), at least one RPC response from the at least one NETCONF server (500); and
storing, by the NETCONF controller (102), the at least one of the configuration modification information, the configuration commitment information, the configuration query, and the configuration status into the at least one NETCONF server (500).

10. The method as claimed in claim 1, wherein the method comprises:
communicating, by the NETCONF controller (102), with a Configuration Management As A Service (CMAAS) (300) of the OSS device (1000) through an Application Programming Interface (API) gateway to access at least one of a parameter library, NETCONF Micro service (MS) information, NETCONF gNodeB (gNB) information, and NETCONF task request.

11. The method as claimed in claim 1, wherein the method comprises:
communicating, by the NETCONF controller (102), with a Configuration Management As A Service (CMAAS) (300) of the OSS device (1000) through a NETCONF controller gateway (103).

12. An Network Configuration Protocol (NETCONF) controller for configuring at least one NETCONF server (500), the NETCONF controller (102) comprising:
a memory (102a); and
a processor (102b): operably connected to the memory (102a), configured to:
establish direct communication between the at least one NETCONF server (500) and an operational support system (OSS) device (1000) using a NETCONF protocol; and
configure the at least one NETCONF server (500) without communicating with an Element Management System (EMS) server upon successful establishment of the direct communication.

13. The NETCONF controller (102) as claimed in claim 12, wherein establish the direct communication between the at least one NETCONF server (500) and the OSS device (1000) using the NETCONF protocol comprises:
receive a Transmission Control Protocol (TCP) connection request from the at least one NETCONF server (500);
establish a TCP connection with the at least one NETCONF server (500) based on receiving the TCP connection request;
establish a Transport Layer Security (TLS) session with the at least one NETCONF server (500) using the established TCP connection; and
establish a NETCONF session with the at least one NETCONF server (500) using the established TLS session.

14. The NETCONF controller (102) as claimed in claim 13, wherein the NETCONF controller (102) further comprises:
maintain the established NETCONF session using a NETCONF supervision process and a watchdog process.

15. The NETCONF controller (102) as claimed in claim 13, wherein establish the TLS session with the at least one NETCONF server (500) using the established TCP connection comprises:
determine at least one of a present host key of the at least one NETCONF server (500) and a present certificate of the at least one NETCONF server (500);
validate the at least one of the present host key and the present certificate based on at least one of a certificate path and a comparison;
determine whether the at least one of the present host key and the present certificate is successfully validated; and
establish the TLS session with the at least one NETCONF server (500) on successful validation of the at least one of the present host key and the present certificate.

16. The NETCONF controller (102) as claimed in claim 15, wherein validate the present certificate based on the certificate path comprises:
utilize the certificate path to confirm whether the present certificate is a valid chain of trust to a preconfigured issuer certificate to establish the TLS session; and
encode the present certificate with an identifier that the at least one NETCONF server (500) was aware of prior to the connection attempt to establish the TLS session.

17. The NETCONF controller (102) as claimed in claim 15, wherein the validate the at least one of the present host key and the present certificate based on the comparison comprises:
compare the present host key with a previously trusted host key to establish the TLS session; and
compare the present certificate with a previously trusted certificate to establish the TLS session.

18. The NETCONF controller (102) as claimed in claim 14, wherein the NETCONF supervision process comprises:
identify at least one of a virtual identity of the at least one NETCONF server (500) and a physical identity of the at least one NETCONF server (500);
identify at least one of a serial number of the at least one NETCONF server (500) and a hostname of the at least one NETCONF server (500);
determine a channel object based on the at least one of the serial number and the hostname;
create a map to store the channel object; and
store the at least one NETCONF server (500) with a unique key and priority, wherein the at least one NETCONF server (500) executes a task based on the priority.

19. The NETCONF controller (102) as claimed in claim 14, wherein maintain the established NETCONF session using the NETCONF supervision process and a watchdog process comprises:
receive a supervision notification message from the at least one NETCONF server (500);
perform the NETCONF supervision process upon receiving the supervision notification message to maintain the established NETCONF session;
send a watchdog request to the at least one NETCONF server (500), wherein the watchdog request comprises a time interval information associated with the supervision notification message; and
perform the watchdog process upon receiving the watchdog request to maintain the established NETCONF session.

20. The NETCONF controller (102) as claimed in claim 12, wherein configure the at least one NETCONF server (500) without communicating with the EMS server upon successful establishment of the direct communication comprises:
generate configuration of a first day and a second day for the at least one NETCONF server (500);
push the generated configuration to the at least one NETCONF server (500) without communicating with the EMS server;
send at least one Remote procedure call (RPC) request to the at least one NETCONF server (500), wherein the at least one RPC request comprises at least one of configuration modification information, configuration commitment information, configuration query, and configuration status; and
receive at least one RPC response from the at least one NETCONF server (500); and
store the at least one of the configuration modification information, the configuration commitment information, the configuration query, and the configuration status into the at least one NETCONF server (500).

21. The NETCONF controller (102) as claimed in claim 12, wherein the NETCONF controller (102) comprises:
communicate with a CMAAS (300) of the OSS device (1000) through an Application Programming Interface (API) gateway to access at least one of a parameter library, NETCONF Micro service (MS) information, NETCONF gNodeB (gNB) information, and NETCONF task request.

22. The NETCONF controller (102) as claimed in claim 12, wherein the NETCONF controller (102) comprises:
communicate with a Configuration Management As A Service (CMAAS) (300) of the OSS device (1000) through a NETCONF controller gateway (103).

23. A Computer Program Product (CPP) for configuring at least one Network Configuration Protocol (NETCONF) server (500) by a NETCONF controller (102), wherein the CPP comprises:
a computer executable program code recorded on a computer readable non-transitory storage medium, wherein said computer executable program code when executed causing actions including:
establishing direct communication between the at least one NETCONF server (500) and an operational support system (OSS) device (1000) using a NETCONF protocol; and
configuring the at least one NETCONF server (500) without communicating with an Element Management System (EMS) server upon successful establishment of the direct communication.
